(19) United States
(12) Patent Application Publication
(10) Pub. No.: US 2015/0009534 A1
(43) Pub. Date: Jan. 8, 2015

(54) OPERATION APPARATUS, IMAGE FORMING APPARATUS, METHOD FOR CONTROLLING OPERATION APPARATUS, AND STORAGE MEDIUM

(71) Applicant: CANON KABUSHIKI KAISHA, Tokyo (JP)

(72) Inventor: Seijiro Morita, Kawasaki-shi (JP)

(21) Appl. No.: 14/321,684

(22) Filed: Jul. 1, 2014

(30) Foreign Application Priority Data
Jul. 4, 2013 (JP) 2013-140973

(51) Int. Cl. H04N 1/00

(52) U.S. Cl. CPC H04N 1/0044; H04N 1/00392; H04N 1/00395; H04N 1/00411; H04N 1/0048
USPC 358/1.15

(57) ABSTRACT

A multifunction peripheral (MFP) provided with an operation apparatus according to the present invention includes a liquid crystal display for displaying a preview image of a predetermined page of a file having a plurality of pages, a touch screen for detecting an operation pattern based on a user's touch operation performed on a display surface of the liquid crystal display, and a central processing unit (CPU) for switching the preview image to a preview image of another page of the file or a preview image of a predetermined page of another file according to the operation pattern detected by the touch screen while the preview image is being displayed.

### BACKGROUND OF THE INVENTION

1. Field of the Invention

The present invention relates to an operation apparatus with a display screen operable by a finger- or a pen-touch, such as a touch screen display, for example, and an image forming apparatus including such an operation apparatus.

2. Description of the Related Art

Some image forming apparatuses such as a printer or a digital multifunction peripheral have a function to print image data of photos taken with a digital camera, images downloaded from the Internet, and files of document data. Such an image forming apparatus can be equipped with a touch screen display for displaying a preview image for confirming read images or printed results. The touch screen display can be intuitively and simply operated because instructions are input therein by directly touching its display screen.

In recent years, mobile terminals have become multifunctional and the touch screen display has been used in the display unit of the mobile terminal. Even a work environment of the mobile terminal is becoming not so different from that of a personal computer. In future, a work environment is expected to come into existence where editing work is performed through the screen of the touch screen display.

Some image forming apparatuses are provided with a storage unit formed of a hard disk for storing files. This type of the image forming apparatus stores files acquired by various methods, such as reading by a scanner and receiving from other external apparatuses via a network. Such a function is referred to as “box function.” In the box function, a storage unit for storing files is referred to as “box.” The file stored in the box is directly used in or edited for printing in the image forming apparatus. A system may be constructed by providing the box in an external apparatus such as a server instead of the image forming apparatus. In this case, the image forming apparatus can select a file from the box equipped in the server to use the file.

A user needs to select a file from a plurality of files stored in the box when the image forming apparatus uses the file stored in the box. For this reason, the image forming apparatus displays a list of information required by the user in selecting the file such as the document name, the number of pages, and storage date and time of the file stored in the box (hereinafter referred to as supplementary information). The supplementary information of the file is displayed as the list to make it easy for the user to select a desired file. Some image forming apparatuses improve user's convenience in selecting the file by generating and displaying a thumbnail image or displaying the preview image of the file when the list of the file is displayed.

Japanese Translation of PCT International Application, Publication No. 2010-503130 discusses a method for searching a media item using media files such as an image file and an album or images associated with application. The method discussed in Japanese Translation of PCT International Application No. 2010-503130 allows display of a target pixel and pixel groups excluding the target pixel and sequentially advancing the target pixel.

When the supplementary information of a file is displayed as a list, not all of the supplementary information can be displayed due to display space. In such a case, it is difficult for the user to select a file according to the supplementary information. If the user does not recognize the name of a document and the contents thereof, it is also difficult for the user to select a correct file. When a thumbnail image is displayed, the details of a document cannot be confirmed if pages other than a cover sheet are characteristic.

When a preview image is displayed, the preview image of the file and lists of other files need to be switched back and forth, which deteriorates user convenience. Also, in a technique discussed in Japanese Translation of PCT International Application, Publication No. 2010-503130, similar to the case where a thumbnail image is displayed, the details of a document cannot be confirmed if a page other than a cover sheet is characteristic.

### SUMMARY OF THE INVENTION

The present invention is directed to provide an operation apparatus capable of effectively selecting files in such a manner as to facilitate an operation for switching the preview image of a file.

According to an aspect of the present invention, an operation apparatus includes a display unit, a detection unit, and a control unit. The display unit is configured to display a preview image of a predetermined page of a file having a plurality of pages. The detection unit is configured to detect an operation pattern based on a user's touch operation performed on a display surface of the display unit. The control unit is configured to switch the preview image to a preview image of another page of the file or a preview image of a predetermined page of another file according to the operation pattern detected by the detection unit while the preview image is being displayed.

Further features of the present invention will become apparent from the following description of exemplary embodiments with reference to the attached drawings.

### BRIEF DESCRIPTION OF THE DRAWINGS

FIG. 1 is a schematic diagram of a multifunction peripheral (MFP).

FIG. 2 is a schematic diagram of a touch screen display.

FIGS. 3A, 3B, 3C, and 3D are display examples of preview images.

FIGS. 4A, 4B, 4C, and 4D are display examples of preview images.

FIG. 5 is a flow chart illustrating a process for operating the preview image.

FIG. 6 illustrates a display example of the preview images of a plurality of files.

FIG. 7 illustrates an example of a screen for the user operating a box function.

FIGS. 8A, 8B, and 8C are display examples of preview images.

FIG. 9 is a flow chart illustrating a process for operating the preview image.

FIGS. 10A, 10B, 10C, and 10D are display examples of preview images.

FIG. 11 is a flow chart illustrating a process for displaying the preview image.

FIGS. 12A and 12B are display examples of preview images.

FIG. 13 is a flow chart illustrating a process for operating the preview image.

### DESCRIPTION OF THE EMBODIMENTS

Various exemplary embodiments, features, and aspects of the invention will be described in detail below with reference to the drawings.

A digital multifunction peripheral serving as an image forming apparatus equipped with an operation apparatus according to a first exemplary embodiment is communicably connected to an external apparatus such as a print server or a client computer via a network. The digital multifunction peripheral, for example, acquires print data from the client computer via the network to allow printing of a document or an image according to the acquired print data or storing of the print data in a built-in box. In this case, the client computer may transmit the print data to the print server and the print server may instruct the digital multifunction peripheral to perform print processing or file-storage processing. While the above is a general configuration, a configuration may also be adopted in which a plurality of computers and digital multifunction peripherals used by the user is provided.

[Configuration of the image forming apparatus]

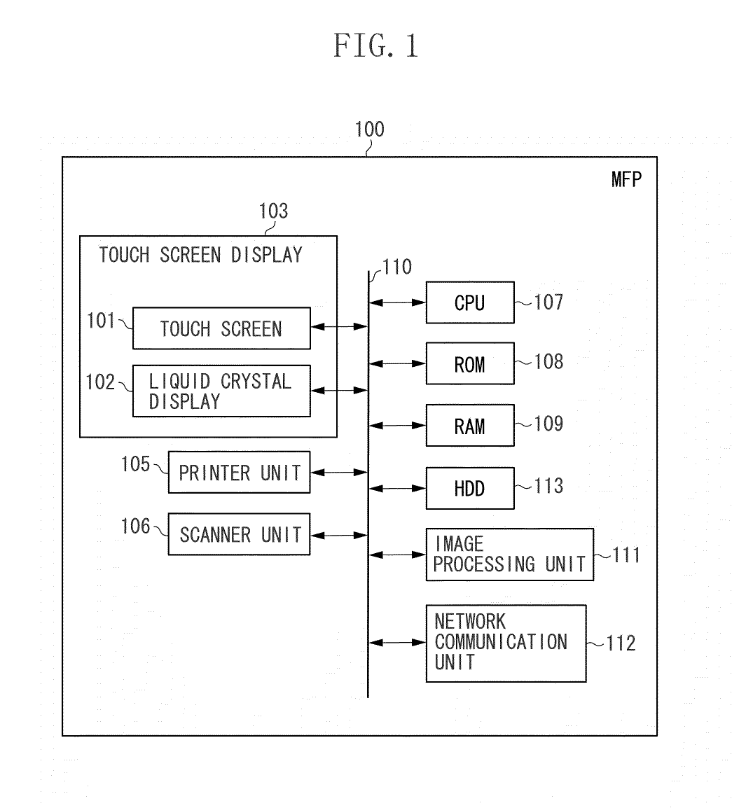

FIG. 1 is a schematic diagram of a digital multifunction peripheral (hereinafter referred to as multifunction peripheral “MFP”) functioning as an image forming apparatus. An MFP 100 includes a system bus 110 capable of transferring data using a direct memory access controller (DMAC). The system bus 110 is connected with a network communication unit 112, a central processing unit (CPU) 107, a read only memory (ROM) 108, a random access memory (RAM) 109, a hard disk drive (HDD) 113, an image processing unit 111, a printer unit 105, and a scanner unit 106. The MFP 100 also includes a touch screen display 103 composed of a touch screen 101 and a liquid crystal display 102. The touch screen 101 and the liquid crystal display 102 are also connected with the system bus 110.

The CPU 107 is a control module which reads and executes the control programs stored in the ROM 108 or the HDD 113 using the RAM 109 as a working area to totally control of the operation of the units in the MFP 100 including data transfer. For example, via the touch screen display 103, instructions for scanning a document are issued. When a document is laid on a document positioning plate (not shown), the CPU 107 causes the scanner unit 106 to read an image on the document. The read data of the document image is referred to as scan data. The scan data are converted into digital data by the scanner unit 106 and stored in the RAM 109 and the HDD 113.

The image processing unit 111 performs image processing such as the coding of various types of data, the decoding of image data received from the external apparatus, the conversion of document data received from the external apparatus into image data, color space conversion, and variable magnification. The printer unit 105 performs print processing for generating an image on a recording paper according to various data received from the scanner 106 or the external apparatus, and discharging the recording paper after the image is generated. The network communication unit 112 transmits and receives files including image data and control commands to and from the external apparatus by wireless communication or via wired network.

Files such as the scan data and document data are stored in the HDD 113. The CPU 107 is instructed by the touch screen 101 to control the RAM 109 and the image processing unit 111 to generate a preview image. The CPU 107 displays the generated preview image on the liquid crystal display 102.

The thus configured MFP 100 can transfer the scan data to the external apparatus such as a print server on the network via the network communication unit 112 and can print the scan data. The MFP 100 can receive a file such as document data from the client computer via the network communication unit 112 and print or store a file such as the scan data and the received document data in the box, and use the file. The HDD 113 is an example of a large capacity storage apparatus for realizing a box used in the box function.

[Touch screen display]

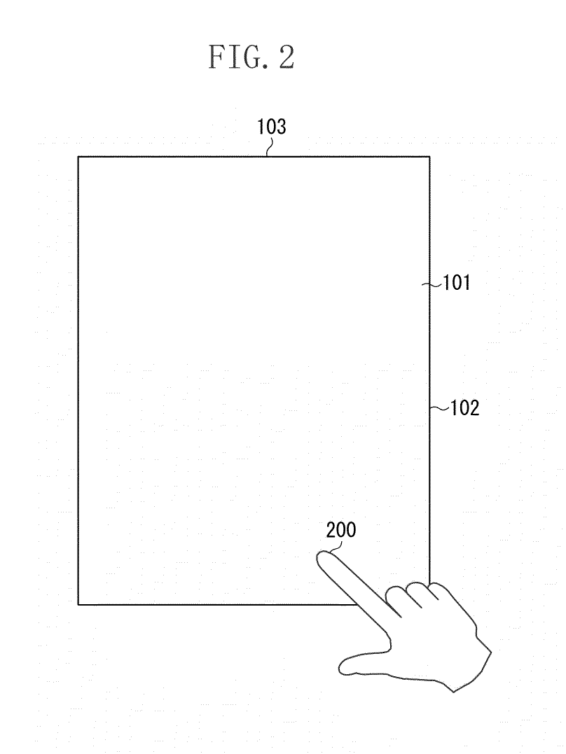

FIG. 2 is a schematic diagram of the touch screen display 103. The touch screen display 103 is configured such that the touch screen 101 formed of a transparent material is arranged on the liquid crystal display 102. The user indirectly touches a display surface of the liquid crystal display 102 to perform touch operation.

The liquid crystal display 102 displays images of various data sent via the system bus 110. Various data include setting menus for various processes of the MFP 100 in addition to the above file such as the scan data and the document data. The touch screen 101 detects a position on the touch screen 101 touched by a finger of the user or a pen (a stylus pen) and a position change. The position where the touch operation is performed is represented by a coordinate on the touch screen 101. The touch screen 101 inputs the detected information representing the detected position and the position change to the CPU 107 via the system bus 110. The detected information is represented by the detected position and position change and is an operation pattern formed by the user's touch operation.

The CPU 107 grasps a position where an image is displayed, on the liquid crystal display 102. Accordingly, the CPU 107 can determine how the user has performed a touch operation on the image based on the information detected by the touch screen 101 and the position where the image is displayed.

Thus, the touch screen display 103 displays various data and receives the input of various processes according to the user's operation. The various processes refer to the selection of operation modes, function setting, operation instructions, the selection of displayed images, screen operations such as touch, drag, pinch, and flick performed therefor, and instructions about position on the display screen.

[Preview Image]

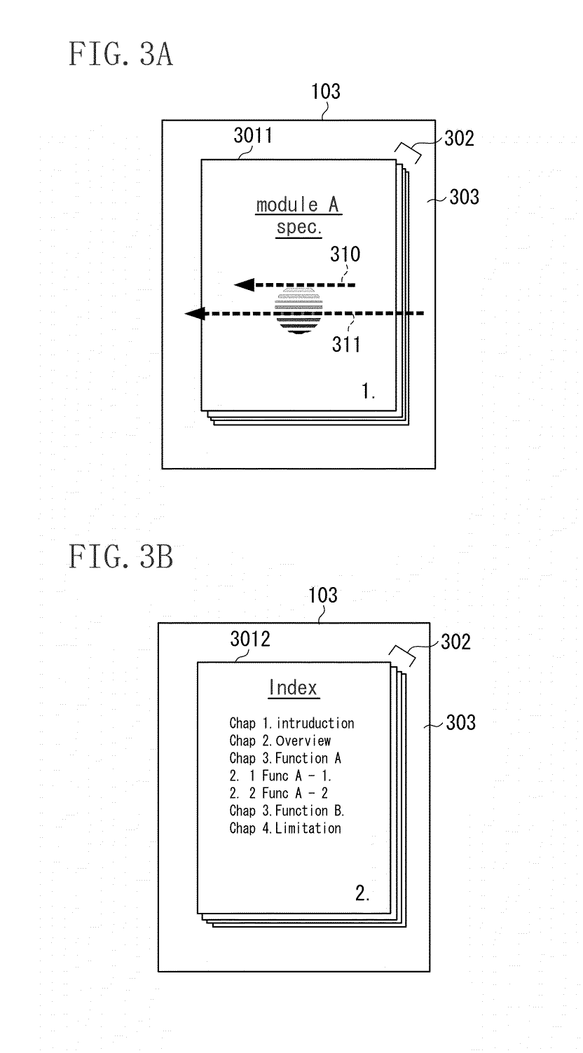

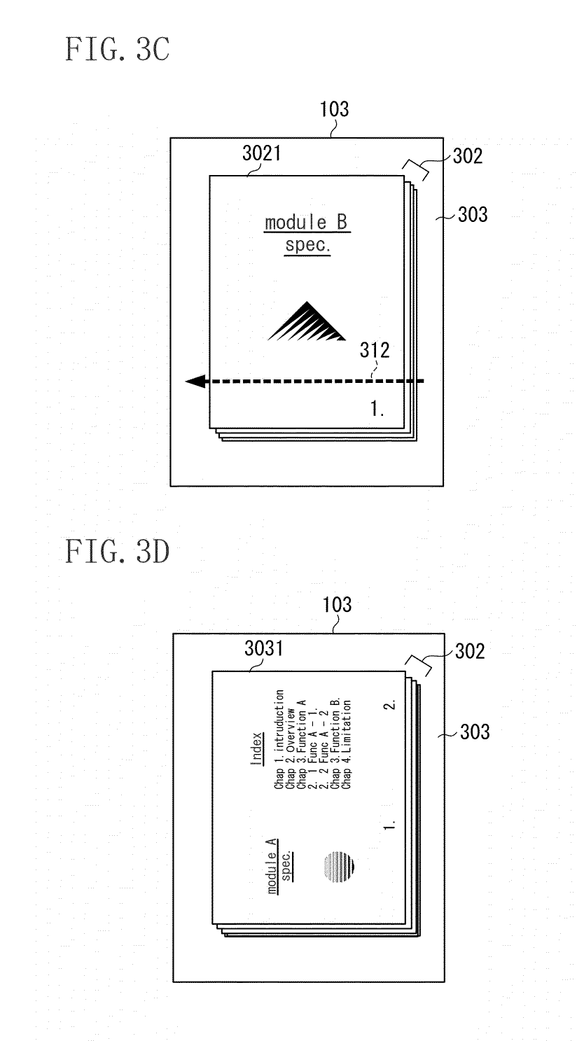

The process where the user confirms a preview image of a file on the touch screen display 103 is described below. FIGS. 3A to 3D illustrate examples of the preview images displayed on the liquid crystal display 102 of the touch screen display 103.

In FIG. 3A, a preview image 3011 on the first page of a file with a plurality of pages stored in the HDD 113 is displayed by the box function of the MFP 100. The CPU 107 causes the image processing unit 111 to generate a preview image 3011 of the file stored in the HDD 113 and displays the preview image 3011 on the liquid crystal display 102. As illustrated in the figure, the file includes a plurality of pages, so that an overlap portion 302 representing the overlap of the pages is displayed. An area 303 where a display object such as the preview image 3011 is not displayed is provided around the preview image 3011.

When other pages of the file, for example the second page, are displayed (i.e., changing page), the user performs a touch operation 310 such as flick starting from the inside of the preview image 3011 in FIG. 3A. Such an operation for changing a page is referred to as “page change operation.” FIG. 3B illustrates an example displayed after the touch operation 310. A preview image 3012 on page 2 of the file is presented on the touch screen display 103.

When the preview image of another file stored in the HDD 113 is displayed (file change), the user performs a touch operation 311 such as flick starting from the area 303 toward the side opposite to an area 303 through the area where the preview image 3011 is displayed. In other words, the user performs the touch operation 311 like crossing the preview image 3011. Such an operation for changing a file is referred to as “file change operation.” FIG. 3C illustrates an example displayed after the touch operation 311. In FIG. 3C, a preview image 3021 on page 1 of a file which is different from the one illustrated in FIG. 3A is displayed on the touch screen display 103. FIG. 3D illustrates an example display after the touch operation 312. A preview image 3031 on page 1 of another file is displayed on the touch screen display 103.

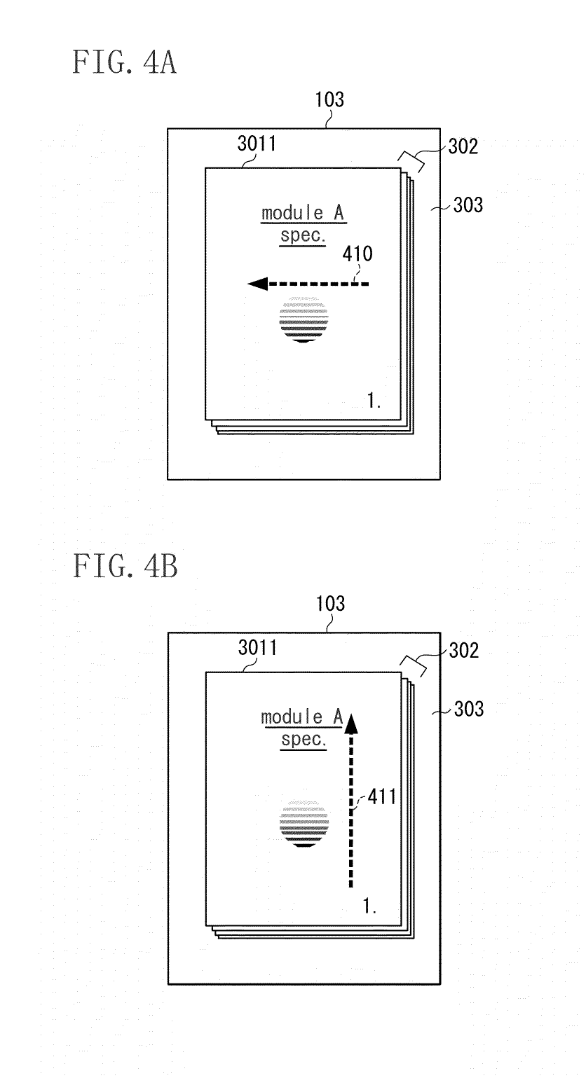

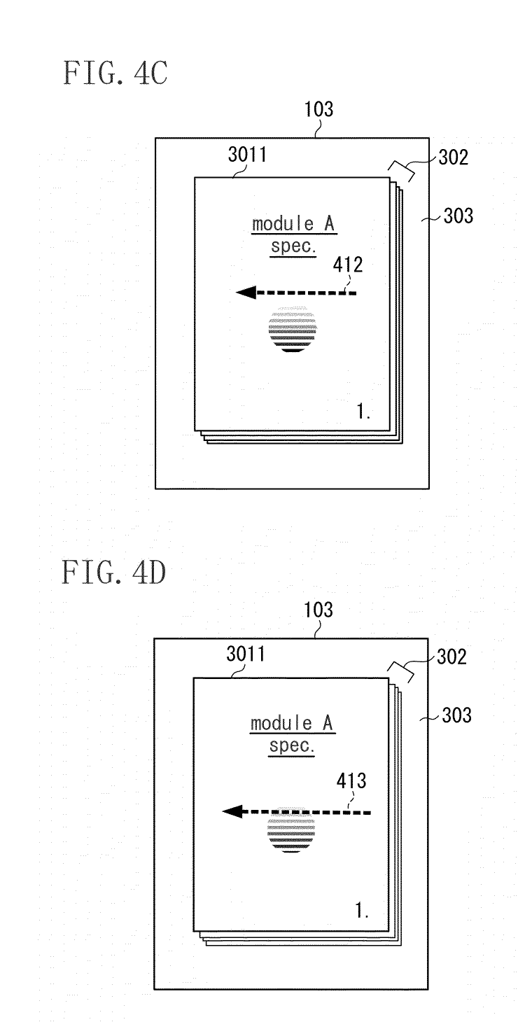

In FIG. 3, the touch operation in the display area for the preview image 3011 is previously set as an operation pattern for the page change operation. The operation starting from the area 303 outside the display area and passing through the display area for the preview image 3011 is previously set as an operation pattern for the file change operation. Such operation patterns may be patterns as illustrated in FIG. 4.

FIGS. 4A and 4B illustrate examples where a touch operation 410 performed in the horizontal direction (one direction) on the display surface of the liquid crystal display 102 is set as an operation pattern for the page change operation and a touch operation 411 performed in the vertical direction (another direction) is set as an operation pattern for the file change operation. FIGS. 4C and 4D illustrate examples where the page change operation and the file change operation are set according to the operation speed of touch operations 412 and 413 (movement speed on the touch position). If the operation speed is higher than a predetermined speed, the operation indicates the operation pattern of the page change. If the operation speed is lower than the predetermined speed, the operation indicates the operation pattern of the file change.

[Operation]

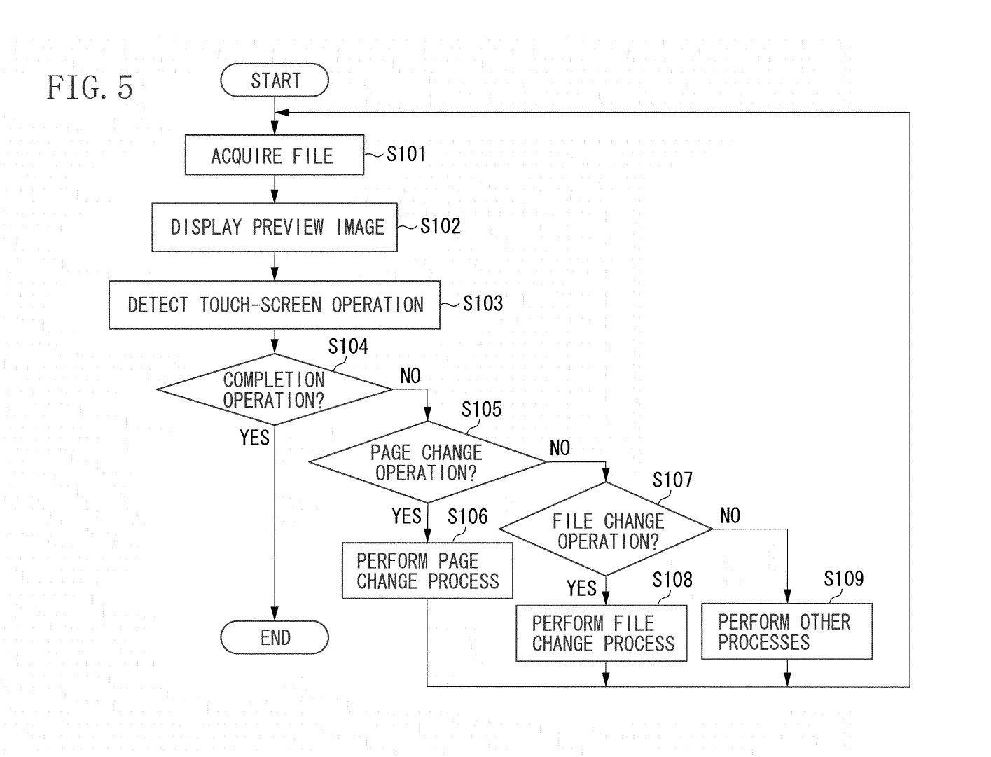

The process of the MFP 100 in switching the preview images illustrated in FIGS. 3 and 4 is described using a flow chart in FIG. 5. The process is executed when the user selects the box including a plurality of files in the box function of the MFP 100 or a screen transitions to a screen for selecting a file to be printed in the MFP 100 from a plurality of files stored in the server.

In step S101, the CPU 107 acquires a file to display the image illustrated in FIG. 3A on the touch screen display 103. The file is composed of image data and print data of a plurality of pages and stored in the box with the form including the supplementary information. The box includes the HDD 113, a server (not illustrated), and the RAM 109. The supplementary information includes the name of the file, storing date and time, the number of pages, and print setting. The CPU 107 first acquires the file displaying a preview image according to a predetermined method, for example, in the order of date or in the order of file names. The CPU 107 sets a document pointer dP indicating which file is acquired among a plurality of files included in the box and a page pointer pP indicating what page in the file is displayed. In the present exemplary embodiment, a file and a page to be previewed are indicated by using the document pointer dP and the page pointer pP, however, if the file and the page to be previewed are clear, another method may be used for indication.

In step S102, the CPU 107 generates the preview image from the acquired file using the image processing unit 111, temporarily stores the preview image in the RAM 109, and displays the preview image on the liquid crystal display 102. The preview image is an image on the page indicated by the page pointer pP. The preview image is displayed as illustrated in FIG. 3A. If a file includes a plurality of pages, the CPU 107 displays the overlap portion 302. Displaying the overlap portion 302 allows the user to easily grasp that the previewed file includes a plurality of pages.

In step S103, the CPU 107 detects that the user operates the touch screen 101 while the preview image is being displayed on the liquid crystal display 102. In step S104, the CPU 107 acquires detection information from the touch screen 101 to determine whether an operation pattern indicates a completion operation. The CPU 107 makes the determination based on whether the operation pattern indicated by the detection information conforms to a predetermined completion operation pattern. The completion operation pattern is a touch operation of a completion button (not illustrated) and a touch operation of a cancel key (not illustrated) displayed on the touch screen display 103. If the operation pattern indicates the completion operation (YES in step S104), the CPU 107 finishes the display process for the preview image.

If the operation pattern indicates no completion operation (NO in step S104), in step S105, the CPU 107 determines whether the operation pattern indicates the page change operation. The CPU 107 makes the determination based on whether the operation pattern indicated by the detection information conforms to a predetermined page change pattern. As described above, the page change pattern indicates a flick in the display area for the preview image (the touch operation 310 in FIG. 3A) and a flick in the horizontal direction (the touch operation 410 in FIG. 4A), for example.

If the operation pattern indicates the page change operation (YES in step S105), in step S106, the CPU 107 performs the page change operation. In the page change operation, the CPU 107 determines whether the operation pattern is the one for changing the current page to the next page or the previous page and determines the page to be displayed next. The CPU 107 determines the page to be displayed and then updates the page pointer pP. The CPU 107 determines the page to be displayed next and then returns the processing to step S101 to continue the processing. In the present exemplary embodiment, the processing returns to step S101, however, the processing may return to display process of the preview image in step S102. In step S102, a preview image with the page changed is displayed.

If the operation pattern indicates no page change operation (NO in step S105), in step S107, the CPU 107 determines whether the operation pattern indicates the file change operation. The CPU 107 makes the determination based on whether the operation pattern indicated by the detection information conforms to a predetermined file change pattern. As described above, the file change pattern indicates a flick crossing the display area for the preview image (the touch operation 311 in FIG. 3A), a flick in the vertical direction (the touch operation 411 in FIG. 4B), or a flick slower than a predetermined speed (the touch operation 413 in FIG. 4D), for example.

If the operation pattern indicates the file change operation (YES in step S107), in step S108, the CPU 107 performs the file change operation. In the file change operation, the CPU 107 determines whether the operation pattern is the one for displaying the next file or the previous file and determines the file to be displayed next. The next or the previous file refers to “next” or “previous” in the order of a file name or in the order of date given to a file. When the CPU 107 determines the file to be displayed, the CPU 107 renews the document pointer dP. After the CPU 107 determines the file to be displayed next, the processing returns to step S101. In step S101, the CPU 107 acquires the file to be displayed next. In other words, the CPU 107 acquires a file corresponding to the updated document pointer dP from the HDD 113 or the box such as a server. After the CPU 107 acquires the file, in step S102, a preview image acquired after the file is changed is displayed.

The file change operation may be enabled only when the preview image is on the first page or the last page of the file. This prohibits the user from erroneously performing the file change operation.

If the operation pattern indicates no file change operation (NO in step S107), in step S109, the CPU 107 performs other processes determined according to the operation pattern. When the CPU 107 finishes the other processes, the processing returns to step S101. In the present exemplary embodiment, the processing returns to step S101, however, the processing may directly proceed to the display process of the preview image in step S102.

The above process can provide the user interface on which the page change operation and the file change operation can be separately performed using the two operation patterns on the preview image. This eliminates the need for shifting the operation screen for page selection to the operation screen for document selection and vice versa, which simplifies the user's operation process.

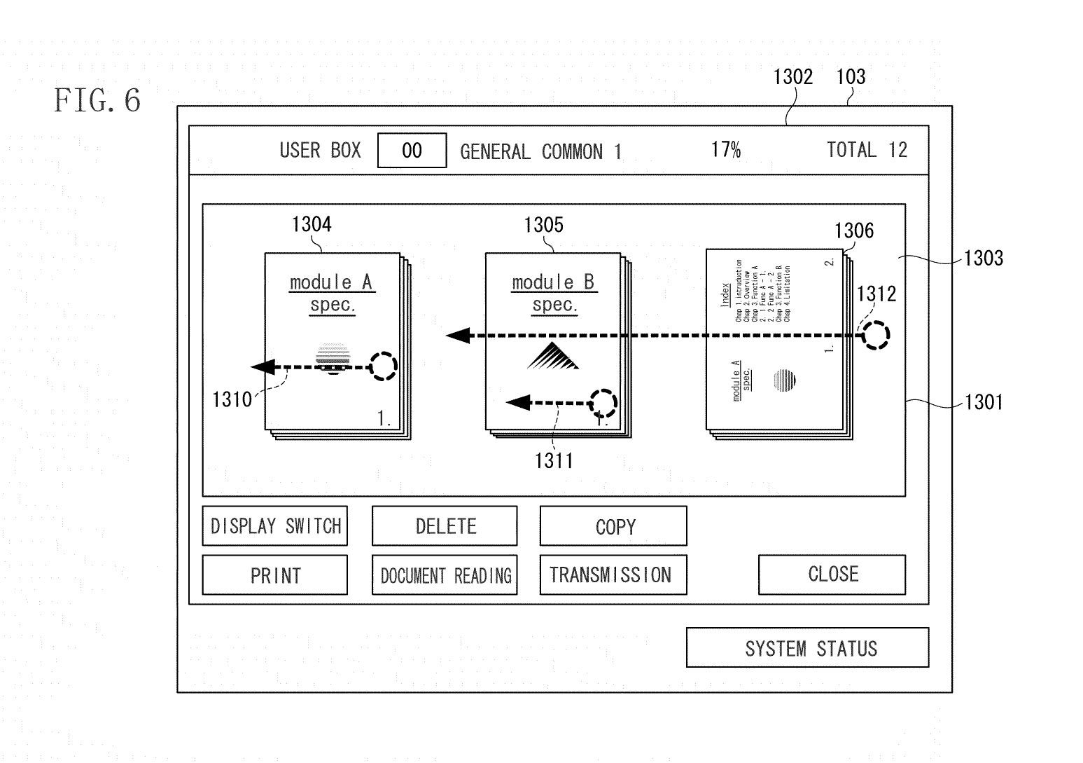

The file change operation may also be applied to the preview images of a plurality of files. FIG. 6 illustrates a display example of the preview images of the plurality of files. In FIG. 6, the preview images of the file categorized as a box number of “00” and a box name of “general common 1” and stored in the HDD 113 by the box function of the MFP 100 are displayed on the touch screen display 103. The preview images each composed of a plurality of pages include a first file of a preview image 1304, a second file of a preview image 1305, and a third file of a preview image 1306. The preview images 1304, 1305, and 1306 are displayed on a preview display area 1301. An information bar 1302 displays information about the box functioning as a storage place. In FIG. 6, a total of 12 files are stored in total in the box.

When the user displays the preview image on the next page in the first file, the user flicks the preview image 1304 (a touch operation 1310). Similarly, when the user displays the preview image on the next page in the second file, the user flicks the preview image 1305 (a touch operation 1311). When the user displays another file stored in the box, the user performs a flick operation (a touch operation 1312) starting from an area 1303 where the preview images 1304, 1305, and 1306 are not displayed. Thereby, the preview images of a third and subsequent files are displayed. The CPU 107 updates the preview images according to the user's touch operation.

The file change operation may be applied to a folder or a box including a plurality of files. The page change operation may also be applied to the displayed images of the file in a folder or a box including a plurality of files.

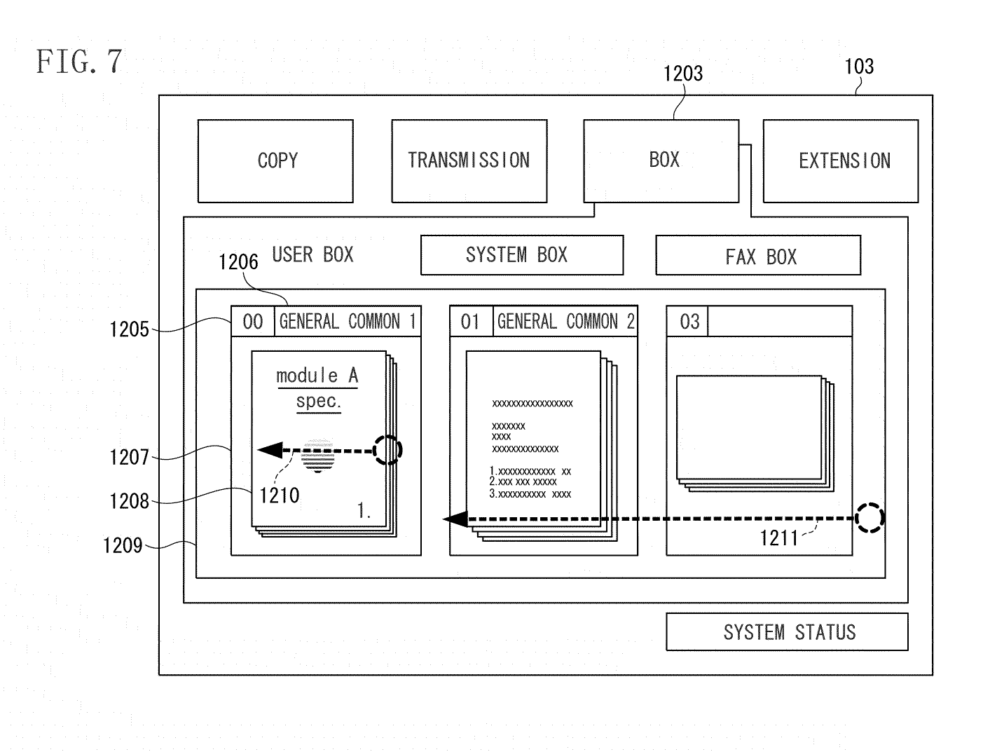

FIG. 7 illustrates an example of a screen for the user operating the box function of the MFP 100. Data storage places with box numbers “00” to “99” are provided in the user box having the box function of the MFP 100. Each user box is capable of storing a plurality of files. When the CPU 107 determines a box 1203 to be displayed in a preview display area 1209, the CPU 107 acquires a file stored in the box 1203 to generate a preview image. The preview image is generated by a format including a file cover image 1208, a box number 1205, and box name 1206 which are included in the box 1203 and displayed as a box preview image 1207 in the preview display area 1209.

In a case where the user confirms a file stored in the box 1203, the user performs a flick in a box preview image 1207 (a touch operation 1210). In a case where the user wants to display another box, the user performs a flick starting from an area outside the display area of the preview image (a touch operation 1211). If the user confirms in detail the file in each box, other predetermined touch operations may be performed such that the screen transitions to that in FIG. 6. Other predetermined operations include, for example, touch operation of the box number 1205, or the continuous press of the preview image for a predetermined time period or longer.

In processing a preview image with a large number of pages, it is convenient to change a plurality of pages at the same time. The second exemplary embodiment describes an operation in this case. In the second exemplary embodiment, also, the MFP 100 similar in configuration to that in the first exemplary embodiment can be used as hardware, so that the description thereof is omitted.

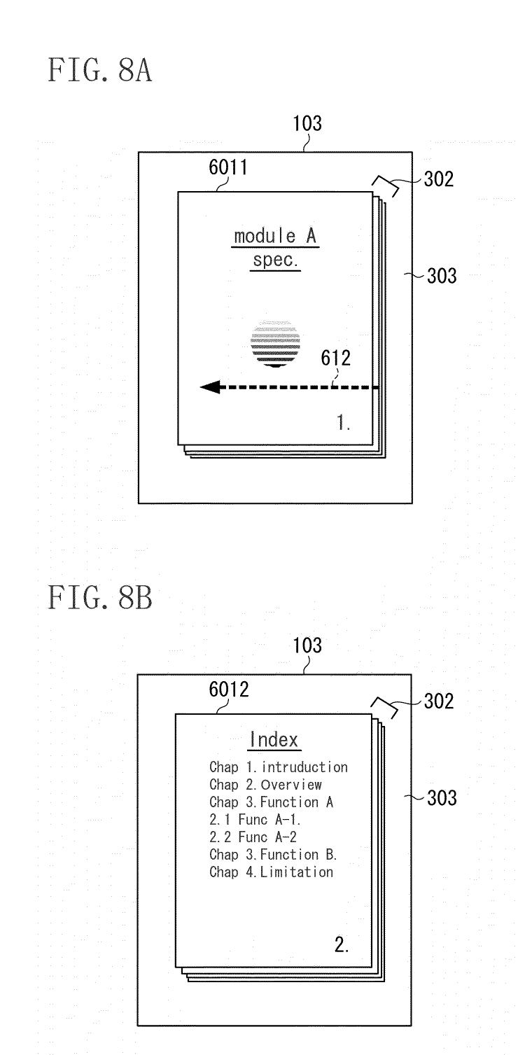

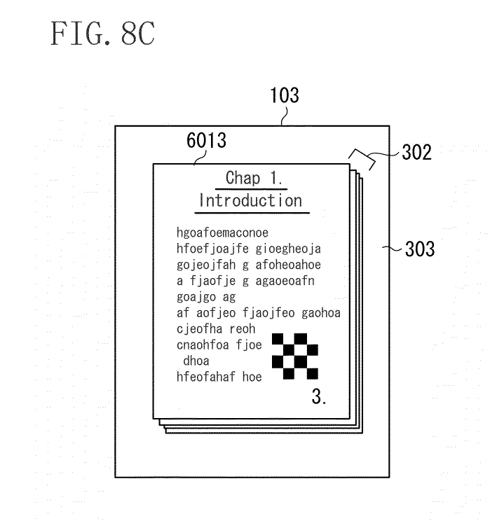

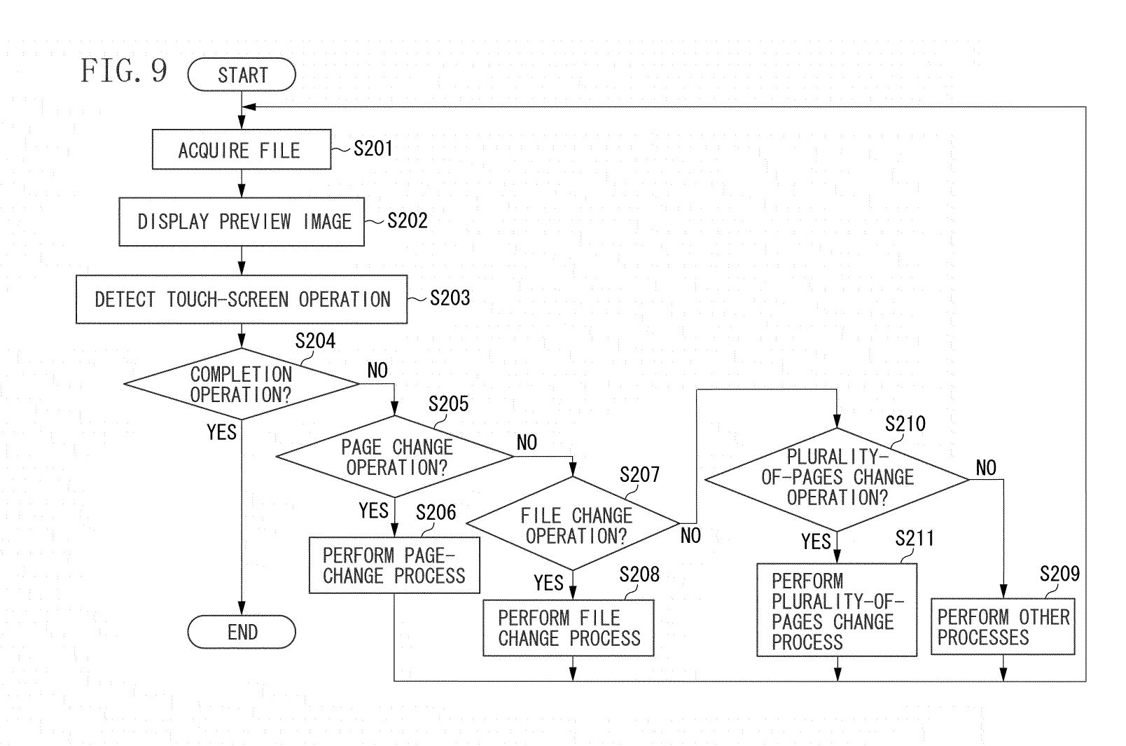

FIGS. 8A to 8C illustrate display examples of operation patterns for page change, file change, and a plurality-of-pages change and a preview image after change. FIG. 9 is a flow chart illustrating a process of the CPU 107 according to the second exemplary embodiment. The processes in steps S201 to S208 and S209 in FIG. 9 are similar to those in steps S101 to S108 and S109 in FIG. 5. Therefore, the description thereof is omitted.

In step S210, if the operation pattern indicates no file change operation (NO in step S207), in step S210, the CPU 107 determines whether the operation pattern indicates a plurality-of-pages change operation. The CPU 107 makes the determination based on whether the operation pattern indicated by the detection information conforms to a predetermined plurality-of-pages change pattern. The plurality-of-pages change pattern is a flick in the display area of a preview image 6011 (an operation 612 in FIG. 8A) starting from the overlap portion 302 of the preview image 6011 in FIG. 8A, for example.

If the operation pattern indicates the plurality-of-pages change operation (YES in step S210), in step S211, the CPU 107 performs a plurality-of-pages change process. In the plurality-of-pages change process, the CPU 107 determines whether pages are changed forward or backward in the operation pattern and determines the page to be displayed next. The CPU 107 determines the page and then updates the page pointer pP. The CPU 107 determines the page to be displayed next and then returns the processing to step S201 to continue the process. In the present exemplary embodiment, the processing returns to step S201, however, the processing may return to display process of the preview image in step S202. In step S202, a preview image with the page changed is displayed.

In step S206, a page is changed one by one (the page pointer pP=pP±1). In step S211, the predetermined number of pages are changed forward, for example, two pages are changed forward, (the page pointer pP=pP±2). FIG. 8C is a display example of a preview image 6013 with two pages changed forward. FIG. 8C is the display example with a plurality of pages as “2” and illustrates a transition from a display state on page 1 in FIG. 8A to a display state on page 3 in FIG. 8C. FIG. 8B illustrates a display state on page 2 and a display example of a preview image 6012 as a result of step S206.

As described above, the second exemplary embodiment can provide a user interface capable of changing a plurality of pages as well as performing two patterns of the page change and the file change patterns.

If print setting such as page setting in printing is added to a file, a preview image is displayed so as to allow the user to easily grasp the print setting to improve the user's convenience. The print setting includes binding processing setting, two-sided printing setting, and page consolidation setting. A third exemplary embodiment describes an operation in this case. In the third exemplary embodiment, also, the MFP 100 similar in configuration to that in the first exemplary embodiment can be used as hardware, so that the description thereof is omitted.

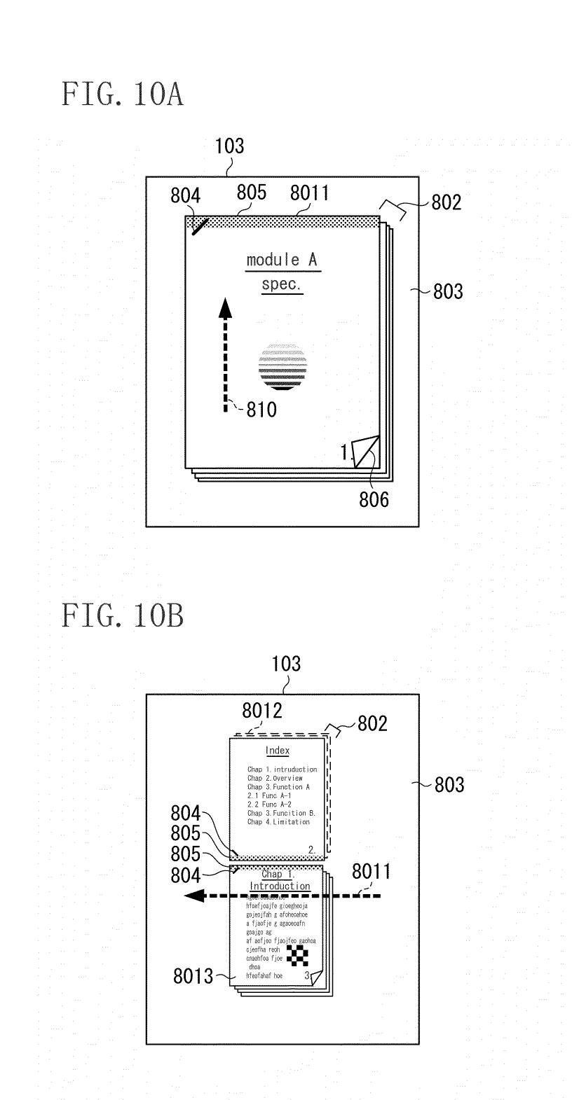

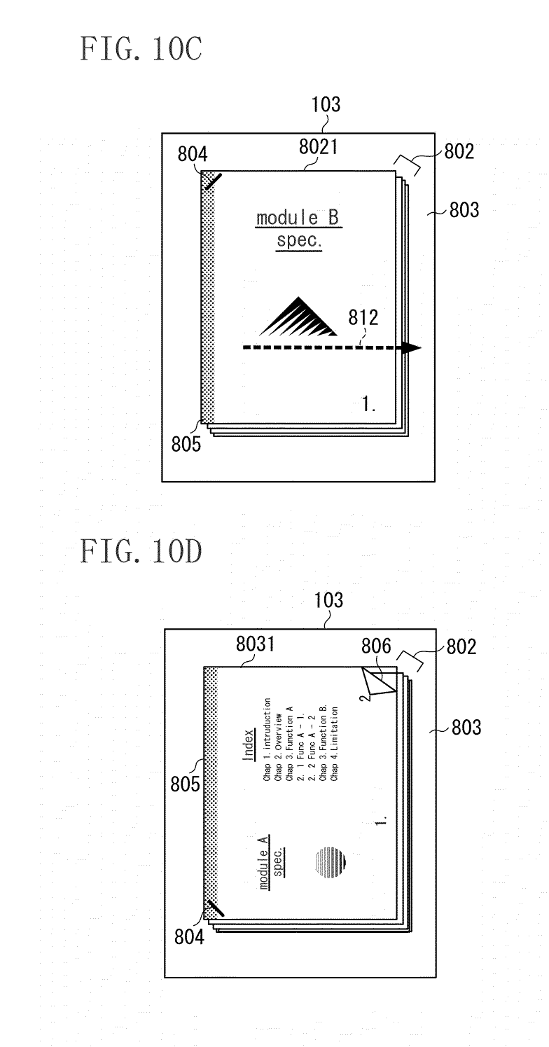

FIGS. 10A to 10D illustrate examples of preview images displayed on the touch screen display 103.

FIG. 10A illustrates a display example of a preview image 8011 on page 1 of a file with a plurality of pages. Because the file includes a plurality of pages, an overlap portion 802 indicating overlapped pages is displayed. An area 803 where a display object such as the preview image 8011 is not displayed is provided around the preview image 8011. The binding processing setting and the two-sided printing setting are provided on the file as the print setting. For this reason, on the preview image 8011 are displayed a staple setting image 804 indicating a staple position, a binding setting image 805 indicating a binding edge, and a two-sided setting image 806 indicating two-sided printing. These images are displayed according to the print setting to allow the user to confirm the print setting of the file.

When the user displays the preview image on page 2 of the file from the display in FIG. 10A, the user flicks the preview image 8011 in the direction in which the page can be turned (a touch operation 810). Since the upper edge of the preview image 8011 is set as a binding edge in FIG. 10A, the flick is performed in the vertical direction.

The touch operation 810 switches the display in FIG. 10A to that in FIG. 10B. Since the two-sided printing is set on the file, a preview image 8012 on page 2 and a preview image 8013 on page 3 of the file are displayed in FIG. 10B as if a two-sided printed document is actually turned.

If the preview image of another file is displayed when the preview image of the current file is displayed, the user flicks the preview images 8012 and 8013 in the direction in which the pages thereof cannot be turned (a touch operation 811). Since the upper edge of the file is set as the binding edge in FIG. 10B, the flick is performed in the horizontal direction.

The touch operation 811 switches the display in FIG. 10B to that in FIG. 10C. In FIG. 10C, the preview image 8021 on page 1 of another file is displayed. Since the binding processing is set on the file, the staple setting image 804 and the binding setting image 805 are displayed on the preview image 8021. The two-sided printing setting is not provided.

If the preview image of another different file is displayed when the preview image of the current file is displayed, the user performs a flick in the direction in which the page cannot be turned (a touch operation 812). Since the left edge of the file is set as the binding edge in FIG. 10C, the flick is performed from left to right. The touch operation 812 switches the display in FIG. 10C to that in FIG. 10D. In FIG. 10D, the preview image 8031 on page 1 of another different file is displayed.

The touch operation is inhibited by the print setting. The touch operation performed in the direction of a binding edge brings the page change operation. The touch operation performed in the other direction brings the file change operation. The direction in which the touch operation is inhibited is represented by the binding setting image 805.

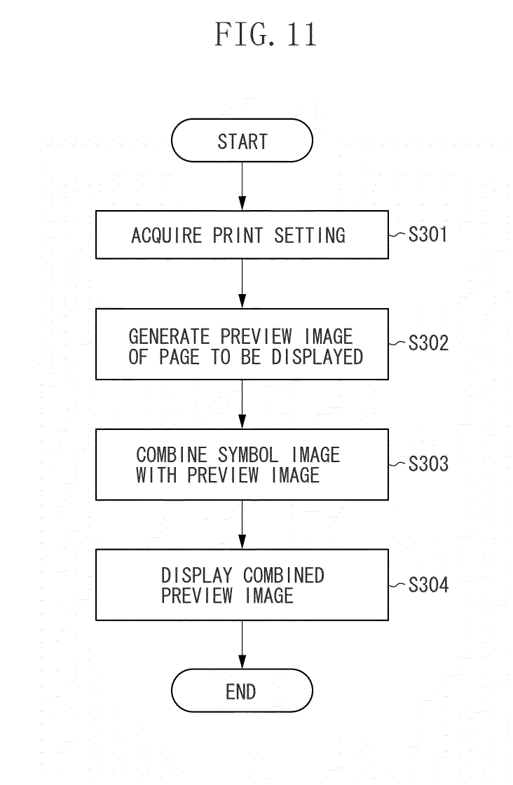

When the above display is performed, the MFP 100 executes the process illustrated by a flow chart in FIG. 5. In the process in step S102 illustrated in FIG. 5, the preview image is not merely displayed, so that the CPU 107 performs the process illustrated in the flow chart in FIG. 11.

In step S301, the CPU 107 acquires print setting information indicating the print setting added to a file. In step S302, the CPU 107 causes the image processing unit 111 to generate a preview image based on the page to be displayed and the print setting information. In the example of FIG. 10B, the page to be displayed is “2” (page pointer pP=2). The CPU 107 determines that the preview image on the next page “3” also needs to be displayed based on the print setting information about two-sided printing and binding setting and generates the preview images 8012 and 8013 using image data for two pages.

In step S303, the CPU 107 causes the image processing unit 111 to combine a staple setting image 804, a binding setting image 805, and a two-sided setting image 806 with the preview images based on the print setting information. Symbol images of the staple setting image 804, the binding setting image 805, and the two-sided setting image 806 are previously stored in the HDD 113. The CPU 107 reads the symbol images from the HDD 113 based on the print setting information and combines the symbol images with the preview images. In step S304, the CPU 107 displays the preview images combined with the symbol images on the liquid crystal display 102. The user can confirm the preview images of the file and the print setting based on the preview images displayed by such processing.

In a third exemplary embodiment, in step S105 illustrated in FIG. 5, the CPU 107 determines whether the operation pattern indicates the page change operation depending on whether the operation pattern conforms to the page change pattern determined based on the print setting information. For example, the CPU 107 takes the touch operation performed in the direction in which pages can be turned (the touch operation 810 illustrated in FIG. 10A) as the page change pattern.

In step S107 illustrated in FIG. 5, the CPU 107 determines whether the operation pattern indicates the file change operation depending on whether the operation pattern conforms to the file change pattern determined based on the print setting information. For example, the CPU 107 takes the touch operation performed in the direction in which pages cannot be turned (the touch operation 811 illustrated in FIG. 10B and the touch operation 812 illustrated in FIG. 10C) as the file change pattern.

Thus, in the third exemplary embodiment, the user interface based on the print setting can be provided, so that intuitive page change and file change can be performed.

If the display area of the touch screen display 103 is small, the page change operation may be mistaken for the file change operation or vice versa. In the fourth exemplary embodiment, such an erroneous operation is prevented. In the fourth exemplary embodiment, also, the MFP 100 similar in configuration to that in the first exemplary embodiment can be used as hardware, so that the description of hardware configuration is omitted.

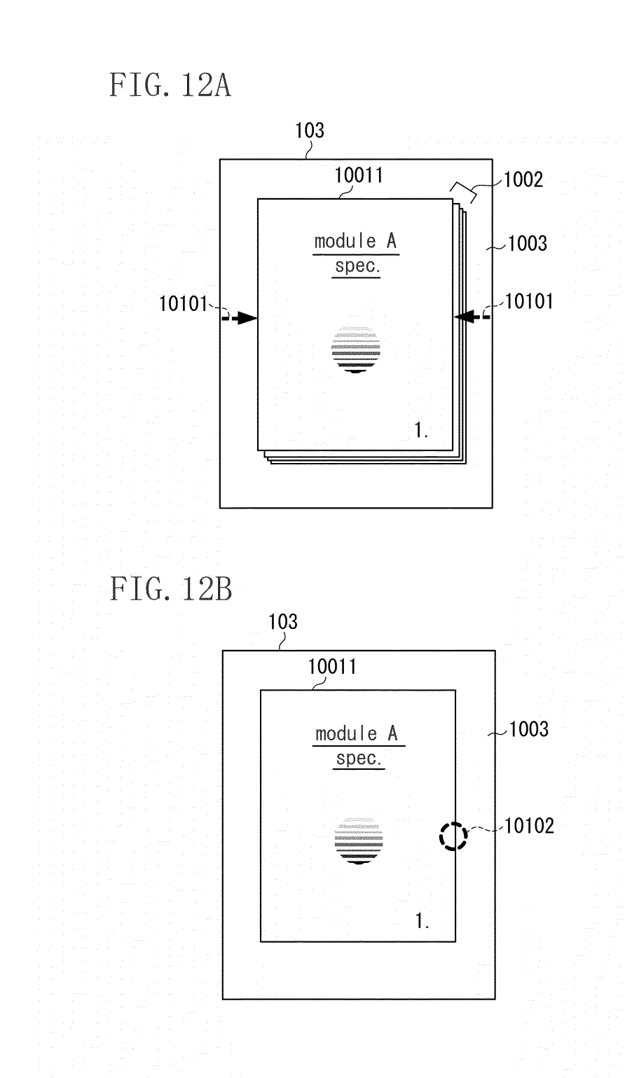

FIGS. 12A and 12B are display examples illustrating preview images displayed on the touch screen displays 103. FIG. 12A is similar to FIG. 3A which is the display example according to the first exemplary embodiment. FIG. 12A differs only in a touch operation 10101 from the first exemplary embodiment. In the first exemplary embodiment, the page change operation and the file change operation are separately performed depending on the direction of the touch operation. In the fourth exemplary embodiment, if the user performs a flick (a touch operation) in a state illustrated in FIG. 12A, the touch operation is the page change operation.

In FIG. 12A, if the user changes a file, the user performs a touch operation 10101 as if the user pinches the edge portions of a preview image 10011 with an area 1003, as a starting point, where display objects such as the preview image 10011 are not displayed. The touch operation 10101 switches the display in FIG. 12A to that in FIG. 12B. In FIG. 12B, an overlap portion 1002 disappears. If the user performs a flick (a touch operation) in a state illustrated in FIG. 12B, the touch operation is the file change operation.

In FIG. 12B, if the user changes a page, the user performs a touch operation 10102 onto the edge of the preview image 10011 for a predetermined period of time. The touch operation 10102 switches the display in FIG. 12B to that in FIG. 12A, which makes it possible to change a page.

Thus, FIG. 12A illustrates a page change mode in which the page change operation can be performed by a flick. FIG. 12B illustrates a file change mode in which the file change operation can be performed by a flick.

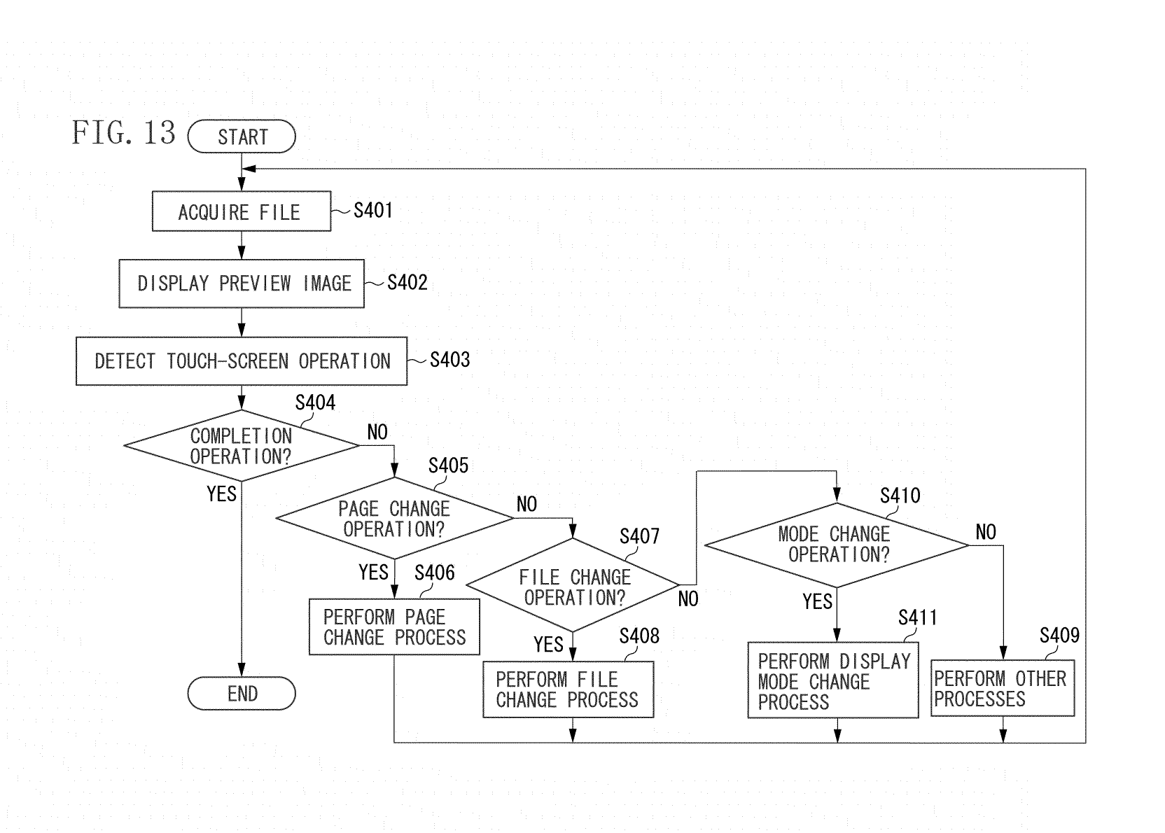

FIG. 13 is a flow chart illustrating a process of the MFP 100 in displaying a preview image according to the fourth exemplary embodiment.

In step S401, the CPU 107 acquires a file. In step S402, the CPU 107 causes the image processing unit 111 to generate a preview image from the file and displays the preview image on the liquid crystal display 102. The CPU 107 switches the display of the preview image with reference to a change mode flag indicating either a page change operation mode or a file change operation mode. If the change mode flag indicates the page change operation mode, the preview image is displayed as illustrated in FIG. 12A. If the change mode flag indicates the file change operation mode, the preview image is displayed as illustrated in FIG. 12B.

In step S403, the CPU 107 detects that the user operates the touch screen 101 while the preview image is being displayed. The CPU 107 acquires detection information from the touch screen 101. Otherwise (NO in step S404), in step S405, the CPU 107 determines whether the operation pattern indicates the page change operation based on the acquired detection information and the change mode flag. If the CPU 107 determines that the page change operation is ineffective with reference to the change mode flag (NO in step S405), in step S407, the CPU 107 determines whether the operation pattern indicates the file change operation. If the CPU 107 determines that the page change operation is effective in the change mode flag, the CPU 107 makes the determination as to whether the operation pattern indicates the page change operation based on whether the operation pattern indicated by the detection information conforms to a predetermined page change operation pattern. If the CPU 107 determines that the operation pattern indicates the page change operation (YES in step S405), in step S406, the CPU 107 performs the page change process.

If the operation pattern indicates no page change operation (NO in step S405), in step S407, the CPU 107 determines whether the operation pattern indicates the file change operation. The CPU 107 determines whether the file change operation is effective with reference to the change mode flag. If the file change operation is effective, the CPU 107 makes the determination as to whether the operation pattern indicates the file change operation based on whether the operation pattern indicated by the detection information conforms to the predetermined file change pattern. If the operation pattern indicates the file change operation (YES in step S407), in step S408, the CPU 107 performs the file change process.

If the operation pattern indicates no file change process (NO in step S407), in step S410, the CPU 107 determines whether the operation pattern indicates a change mode flag change operation. The CPU 107 makes the determination as to whether the operation pattern indicates the change mode flag change operation based on whether the operation pattern indicated by the detection information conforms to the predetermined change mode flag change pattern. If the page change is effective, for example, the change mode flag change pattern indicates the touch operation by the user pinching the preview image (a touch operation 10101 in FIG. 12A). If the file change is effective, the change mode flag change pattern indicates the operation of touching the edge of the preview image for a predetermined time period or longer (the touch operation 10102 in FIG. 12B).

Such a process can provide a user interface for switching between the page change operation and the file change operation on a one preview screen. For this reason, if the touch screen display 103 is small in display area, in particular, user's operability is improved.

The present invention can also be realized by executing the following process. That is, the process is performed such that software (a program) realizing the functions of the above exemplary embodiments is supplied to a system or an apparatus via a network or various storage media and a computer (or a CPU or an MPU) of the system or the apparatus reads and executes the program.

According to the present invention, files can be effectively selected because the preview image of a file can be easily switched.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-140973 filed Jul. 4, 2013, which is hereby incorporated by reference herein in its entirety.

What is claimed is:

1. An operation apparatus comprising:
a display unit configured to display a preview image of a predetermined page of a file having a plurality of pages;
a detection unit configured to detect an operation pattern based on a user's touch operation performed on a display surface of the display unit; and
a control unit configured to switch the preview image to a preview image of another page of the file or a preview image of a predetermined page of another file according to the operation pattern detected by the detection unit while the preview image is being displayed.

2. The operation apparatus according to claim 1, further comprising a setting unit configured to previously set a page change operation pattern for switching the preview image to the preview image of another page and a file change operation pattern for switching the preview image to a preview image of a predetermined page of another file, wherein
the control unit determines whether the operation pattern detected by the detection unit indicates the page change operation pattern or the file change operation pattern, and if the operation pattern indicates the page change operation pattern, the control unit switches the preview image to a preview image of a next page of the file, or if the operation pattern indicates the file change operation pattern, the control unit switches the preview image to a preview image of a predetermined page of another file.

3. The operation apparatus according to claim 2, wherein, if the operation pattern detected by the detection unit indicates a touch operation starting from the inside of the display area of the preview image displayed on the display unit, the control unit determines that the operation pattern indicates the page change operation pattern, or if the operation pattern detected by the detection unit indicates a touch operation starting from the outside of the display area of the preview image displayed on the display unit, the control unit determines that the operation pattern indicates the file change operation pattern.

4. The operation apparatus according to claim 2, wherein, if the operation pattern detected by the detection unit indicates a touch operation performed in one direction on the display surface of the display unit, the control unit determines that the operation pattern indicates the page change operation pattern, or if the operation pattern detected by the detection unit indicates a touch operation performed in the other direction on the display surface of the display unit, the control unit determines that the operation pattern indicates the file change operation pattern.

5. The operation apparatus according to claim 2, wherein, if the speed of a touch operation performed on the operation pattern detected by the detection unit is higher than a predetermined speed, the control unit determines that the operation pattern indicates the page change operation pattern, or if the speed is lower than the predetermined speed, the control unit determines that the operation pattern indicates the file change operation pattern.

6. The operation apparatus according to claim 2, wherein the display unit additionally displays an overlap portion indicating overlapped pages on the preview image and, if the operation pattern detected by the detection unit indicates a touch operation starting from the overlap portion, the control unit switches the preview image to a preview image in which a plurality of pages of the file is changed.

7. The operation apparatus according to claim 2, wherein the touch operation performed in one direction of the preview image displayed by the display unit is prohibited, and if the operation pattern detected by the detection unit indicates the touch operation performed in one direction, the control unit determines that the operation pattern indicates the page change operation pattern, or if the operation pattern indicates the touch operation performed in the other direction, the control unit determines that the operation pattern indicates the file change operation pattern.

8. The operation apparatus according to claim 7, wherein the display unit displays an image indicating that the touch operation performed in one direction of the preview image is prohibited.

9. The operation apparatus according to claim 2, wherein the display unit displays any of a first preview image for switching the current preview image to a preview image of another page and a second preview image for switching the current preview image to a preview image of a predetermined page of another file and
if the detection unit detects the operation pattern while the first preview image is being displayed, the control unit switches the first preview image to the preview image of another page or
if the detection unit detects the operation pattern while the second preview image is being displayed, the control unit switches the second preview image to the preview image of another file.

10. An image forming apparatus comprising:
a display unit configured to display a preview image of a predetermined page of a file having a plurality of pages;
a detection unit configured to detect an operation pattern based on a user's touch operation performed on a display surface of the display unit;
a control unit configured to switch the preview image to a preview image of another page of the file or a preview image of a predetermined page of another file according to the operation pattern detected by the detection unit while the preview image is being displayed; and
an image forming unit configured to form an image according to the preview image.

11. A method for controlling an operation apparatus comprising:
displaying a preview image of a predetermined page of a file having a plurality of pages;
detecting an operation pattern based on a user's touch operation performed on a display surface of a display; and
switching the preview image to a preview image of another page of the file or a preview image of a predetermined page of another file according to the operation pattern detected by the detecting while the preview image is being displayed.

12. A computer readable storage medium storing a program for causing a computer to execute the control method according to claim 11.
